(19) United States
(12) Patent Application Publication
(10) Pub. No.: US 2012/0027621 A1
(43) Pub. Date: Feb. 2, 2012

(54) ELECTRIC MOTOR SYSTEM

(76) Inventors: Chi Ping SUN, Hong Kong (CN); Qiu Bao WANG, Shenzhen (CN); Hai Bo JIANG, Shenzhen (CN)

(21) Appl. No.: 13/192,937

(22) Filed: Jul. 28, 2011

(30) Foreign Application Priority Data
Jul. 28, 2010 (CN) 201010239681.9

(51) Int. Cl. F04B 49/06; H02P 6/04

(52) U.S. Cl. 417/45; 318/400.01

(57) ABSTRACT

An electric motor system has a first electric motor, a second electric motor and a control circuit shared by the first motor and the second motor. At least one of the first motor and the second motor is a permanent magnet brushless motor that has a permanent magnet rotor and a stator with stator windings which generate a rotating magnetic field when electrified. The control circuit is configured to control the brushless motor to operate in a synchronous mode so that the rotor rotates in synchronism with the magnetic field of the stator. The electric motor system may be used in a household appliance.

### CROSS REFERENCE TO RELATED APPLICATIONS

This non-provisional patent application claims priority under 35 U.S.C. §119(a) from Patent Application No. 201010239681.9 filed in The People's Republic of China on Jul. 28, 2010.

### FIELD OF THE INVENTION

This invention relates to a control circuit for a permanent magnet brushless motor and in particular, to a household appliance with at least two pumps.

### BACKGROUND OF THE INVENTION

US2010/0186787 discloses a dishwasher having at least one conveying unit for conveying washing fluid. The conveying unit has a first pump and a second pump, each with a permanent magnet brushless motor. A shared control circuit electronic device is provided for the first and the second pump of the conveying unit. The control circuit electronic device is configured to detect the position of the motor rotor to time the commutation and to detect rotation speed of the rotor to change rotation direction of the rotor when the detected speed deviates from a preset speed. In this application, the motor has the characteristic that the rotor speed increases with increasing torque of the motor. Besides, as the motor speed and frequency of the voltage output by the inverter of the control circuit electronic device have a constant proportional relationship, the motor also has the characteristic that the motor speed varies with variation of the frequency. As detection of position and speed of the rotor are required, the control circuit electronic device is complicated and expensive.

The present invention aims to provide a simpler and cheaper control solution.

### SUMMARY OF THE INVENTION

Accordingly, in a first aspect thereof the present invention provides an electric motor system comprising a first electric motor, a second electric motor and a control circuit shared by the first motor and the second motor, wherein at least one of the first motor and the second motor is a permanent magnet brushless motor which comprises a permanent magnet rotor and a stator with stator windings which generate a rotating magnetic field when electrified; and the control circuit is configured to control the brushless motor to operate in a synchronous mode so that the rotor rotates in synchronism with the magnetic field of the stator.

Preferably, the control circuit is configured to control the first motor and the second motor alternately.

Preferably, the system further comprises a switching unit connected between the control circuit and the two motors.

Preferably, the control circuit comprises an inverter for driving the first motor and the second motor, and a logic control unit which is configured to output PWM signals to the inverter to make the inverter output a sinusoidal wave type driving voltage with a fixed frequency.

Preferably, the control circuit further comprises a detecting unit for detecting load variation of the brushless motor, and a voltage adjusting unit for adjusting power supplied to the brushless motor when the load varies.

Preferably, the voltage adjusting unit is configured to increase the driving voltage when the load on the brushless motor increases and to decrease the driving voltage when the load on the brushless motor decreases.

Preferably, the detecting unit is configured to detect load variation by detecting current passing through the brushless motor.

Preferably, the voltage adjusting unit is configured to adjust the driving voltage by adjusting duty cycles of the PWM signals.

According to a second aspect, the present invention also provides a household appliance comprising a first pump, a second pump, a first motor for driving the first pump, a second motor for driving the second pump, and a control circuit shared by the first motor and the second motor, wherein at least one of the first motor and the second motor is a permanent magnet brushless motor which comprises a permanent magnet rotor and a stator with stator windings which generate a rotating magnetic field when electrified; and the control circuit is configured to control the brushless motor to operate in a synchronous mode so that the rotor rotates in synchronism with the magnetic field of the stator.

Preferably, the control circuit comprises an inverter for driving the first motor and the second motor, and a logic control unit which is configured to output PWM signals to the inverter to make the inverter output a sinusoidal wave type driving voltage with a fixed frequency.

Preferably, the control circuit further comprises a detecting unit for detecting load variation of the brushless motor, and a voltage adjusting unit which is configured to increase the driving voltage when the load of the brushless motor increases and to decrease the driving voltage when the load of the brushless motor decreases.

According to a third aspect, the present invention also provides an electric motor system comprising: a permanent magnet brushless motor which comprises a permanent magnet rotor and a stator with stator windings which generate a rotating magnetic field when electrified; and a control circuit for driving the brushless motor, wherein the control circuit is configured to control the brushless motor to operate in a synchronous mode so that the rotor rotates in synchronism with the magnetic field of the stator.

Preferably, the control circuit comprises an inverter, and a logic control unit which is configured to outputting PWM signals to the inverter to make the inverter output a sinusoidal wave type driving voltage with a fixed frequency.

Preferably, the control circuit further comprises a detecting unit for detecting load variation of the brushless motor, and a voltage adjusting unit which is configured to increase the driving voltage when the load on the brushless motor increases and to decrease the driving voltage when the load on the brushless motor decreases.

In embodiments of the present invention, as the first motor and the second motor share a control circuit, the circuit cost is low. Secondly, the permanent magnet brushless motor is controlled to operate in a synchronous mode and detection of position and speed of the rotor are not required, therefore the control circuit is simpler and cheaper. Thirdly, by adjusting the driving voltage supplied to the motor according to load variation of the motor, high efficiency is assured.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a block diagram of a dishwasher in accordance with the preferred embodiment of the present invention; and

FIG. 2 is a block diagram of an electric motor system in the dishwasher of FIG. 1.

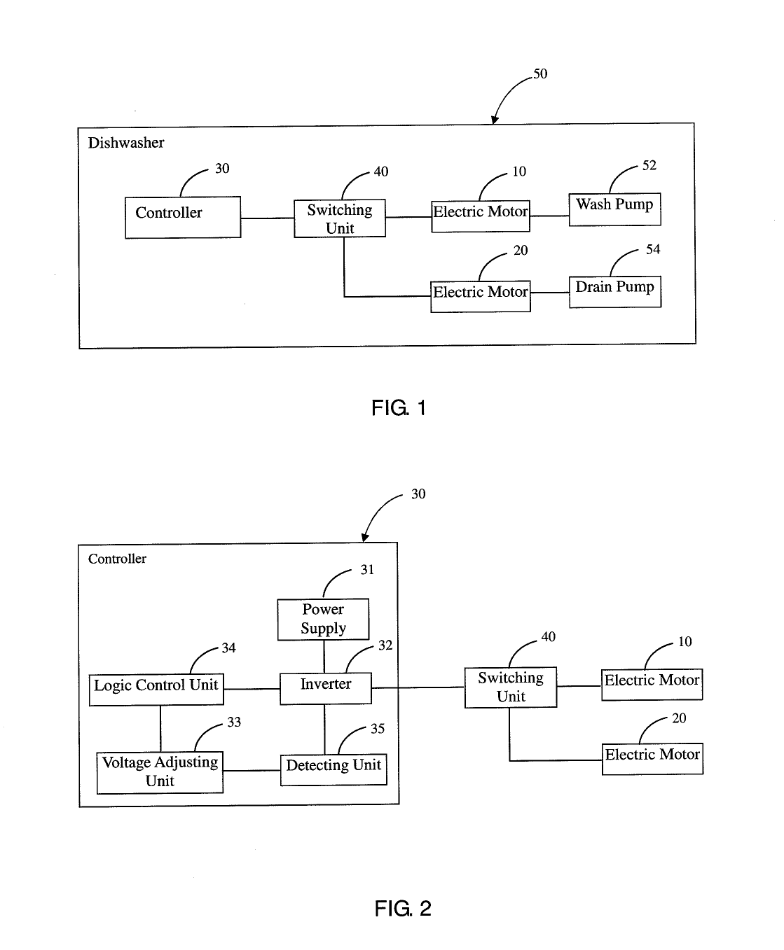

### DETAILED DESCRIPTION OF THE PREFERRED EMBODIMENTS

A dishwasher 50 in accordance with a preferred embodiment of the present invention comprises a tub, a number of wash arms in the tub, a number of spray outlets in the wash arms, a water supply system for supplying water to the tub and a sump for collecting the water from the tub, which are known to the person having ordinary skill in the art and are not shown in the figures. The dishwasher further comprises a wash pump 52 for supplying water from the sump to the wash arms, a drainage system with a drain pump 54 for discharging waste water, and an electric motor system which includes a first electric motor 10 for driving the wash pump 10, a second electric motor 20 for driving the drain pump 54, a control circuit 30 shared by the first motor 10 and the second motor 20, and a switching unit 40 connected between the control circuit 30 and the two motors 10, 20.

Each of the motors 10, 20 is a three phase permanent magnet brushless motor which has a permanent magnet rotor and a stator with stator windings.

The control circuit 30 comprises an inverter 32, a voltage adjusting unit 33, a logic control unit 34, and a detecting unit 35.

The switching unit 40 is connected between the inverter 32 and the two motors 10, 20 and is controlled to connect the first motor 10 or the second motor 20 with the inverter 32 so as to operate the wash pump 52 or the drain pump 54.

The inverter 32 drives the motors 10, 20 and is powered by a power supply 31 which may be a stable DC voltage generated from an AC voltage. The inverter 32 may be a bridge circuit having a plurality of switches. The inverter 32 converts the DC voltage to an alternating voltage with a fixed frequency to be supplied to the stator windings to generate a rotary magnetic field in the stator with a fixed speed.

The logic control unit 34 outputs PWM signals to the inverter 32 to control the switches of the inverter 32 to make the inverter 32 output the alternating voltage.

In this embodiment, the fixed frequency is a preset value. After the motor starts, inverter 32 outputs three phase sinusoidal wave type driving voltages with fixed frequency to drive the motor to operate in a synchronous mode. In the present invention, to operate in a synchronous mode means that the rotor of the motor rotates in synchronism with the rotating magnetic field of the stator and thus rotates at a fixed speed. In this mode, the rotor follows rotation of the stator magnetic field and speed of the rotor does not vary even if the load on the motor varies, that is, the motor has the characteristic that the speed remains constant with variation of the torque. That is, as the frequency of the driving voltages that the inverter 32 provides to the stator windings is fixed, the rotational speed of the stator magnetic field is fixed and the speed of the rotor is also fixed.

The detecting unit 35 detects load variations of the motor by detecting current passing through the stator winding.

The voltage adjusting unit 33 adjusts the power supplied to the motor by adjusting duty cycles of the PWM signals output by the logic control unit 34 when the load of the motor varies so as to prevent the motor from being pulled out of synchronism and to keep the motor efficiency at a relatively high level. Particularly, the voltage adjusting unit 33 is configured to make the driving voltage supplied to the motor increase when the load on the motor increases and to make the driving voltage decrease when the load on the motor decreases.

The permanent magnet brushless motor in this embodiment can be controlled to operate at a constant speed without detection of position or speed of the rotor, so the control circuit is simpler and cheaper.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

For example, the electric motor system may have two or more different motors in which a part of them is permanent magnet brushless motor. Besides, the control circuit may control two or more permanent magnet brushless motors to operate in synchronous mode with the same frequency or different frequencies respectively.

1. An electric motor system comprising a first electric motor, a second electric motor and a control circuit shared by the first motor and the second motor, wherein at least one of the first motor and the second motor is a permanent magnet brushless motor which comprises a permanent magnet rotor and a stator with stator windings which generate a rotating magnetic field when electrified; and the control circuit is configured to control the brushless motor to operate in a synchronous mode so that the rotor rotates in synchronism with the magnetic field of the stator.

2. The system of claim 1, wherein the control circuit is configured to control the first motor and the second motor alternately.

3. The system of claim 2, wherein the system further comprises a switching unit connected between the control circuit and the two motors.

4. The system of claim 1, wherein the control circuit comprises, an inverter for driving the first motor and the second motor, and a logic control unit which is configured to output PWM signals to the inverter to make the inverter output a sinusoidal wave type driving voltage with a fixed frequency.

5. The system of claim 4, wherein the control circuit further comprises a detecting unit for detecting load variation of the brushless motor, and a voltage adjusting unit for adjusting power supplied to the brushless motor when the load varies.

6. The system of claim 5, wherein the voltage adjusting unit is configured to increase the driving voltage when the load on the brushless motor increases and to decrease the driving voltage when the load on the brushless motor decreases.

7. The system of claim 5, wherein the detecting unit is configured to detect load variation by detecting current passing through the brushless motor.

8. The system of claim 5, wherein the voltage adjusting unit is configured to adjust the driving voltage by adjusting duty cycles of the PWM signals.

9. A household appliance comprising a first pump, a second pump, a first motor for driving the first pump, a second motor for driving the second pump, and a control circuit shared by the first motor and the second motor,
wherein at least one of the first motor and the second motor is a permanent magnet brushless motor which comprises a permanent magnet rotor and a stator with stator windings which generate a rotating magnetic field when electrified; and
the control circuit is configured to control the brushless motor to operate in a synchronous mode so that the rotor rotates in synchronism with the magnetic field of the stator.

10. The appliance of claim 9, wherein the control circuit comprises an inverter for driving the first motor and the second motor, and a logic control unit which is configured to output PWM signals to the inverter to make the inverter output a sinusoidal wave type driving voltage with a fixed frequency.

11. The appliance of claim 10, wherein the control circuit further comprises a detecting unit for detecting load variation of the brushless motor, and a voltage adjusting unit which is configured to increase the driving voltage when the load of the brushless motor increases and to decrease the driving voltage when the load of the brushless motor decreases.

12. An electric motor system comprising: a permanent magnet brushless motor which comprises a permanent magnet rotor and a stator with stator windings which generate a rotating magnetic field when electrified; and a control circuit for driving the brushless motor, wherein the control circuit is configured to control the brushless motor to operate in a synchronous mode so that the rotor rotates in synchronism with the magnetic field of the stator.

13. The system of claim 12, wherein the control circuit comprises an inverter, and a logic control unit which is configured to outputting PWM signals to the inverter to make the inverter output a sinusoidal wave type driving voltage with a fixed frequency.

14. The system of claim 13, wherein the control circuit further comprises a detecting unit for detecting load variation of the brushless motor, and a voltage adjusting unit which is configured to increase the driving voltage when the load on the brushless motor increases and to decrease the driving voltage when the load on the brushless motor decreases.
